(19) United States
(12) Patent Application Publication
(10) Pub. No.: US 2019/0077363 A1
(43) Pub. Date: Mar. 14, 2019

(54) SEATBELT ASSEMBLY

(71) Applicant: Ford Global Technologies, LLC, Dearborn, MI (US)

(72) Inventors: David Clyde, Plymouth, MI (US); Christopher Donald Schop, Chelsea, MI (US)

(73) Assignee: Ford Global Technologies, LLC, Dearborn, MI (US)

(21) Appl. No.: 15/702,615

(22) Filed: Sep. 12, 2017

(51) Int. Cl. B60R 22/02; A44B 11/25; B60R 22/34; B60R 22/24; B60R 22/20

(52) U.S. Cl. CPC B60R 22/023; A44B 11/2561; A44D 2203/00; B60R 22/24; B60R 22/201; B60R 22/34

(57) ABSTRACT

A seatbelt assembly includes a seatbelt, a D-ring including a D-ring slot slideably receiving the seatbelt, a tongue including a tongue slot slideably receiving the seatbelt, and a buckle. The D-ring includes at least one of a magnet interface and metal interface. A tongue includes the other of the magnet interface and metal interface. The buckle and the tongue are releasably engageable.

### BACKGROUND

Seatbelts may enhance occupant protection in a vehicle. For example, in impact events and vehicle rollovers, seatbelts can function to reduce secondary impacts, to keep occupants correctly positioned for secondary restraint systems (e.g., airbags), and to assist in preventing occupants from being ejected from the vehicle.

### BRIEF DESCRIPTION OF THE DRAWINGS

FIG. 1 is perspective view of an example vehicle including multiple seatbelt assemblies.

FIG. 2 is a perspective view of an example of a seatbelt assembly.

FIG. 3 is a perspective view of a D-ring, a seatbelt and a tongue of another example of the seatbelt assembly.

FIG. 4 is a side view of the D-ring and the tongue of the example of the seatbelt assembly of FIG. 3.

### DETAILED DESCRIPTION

A seatbelt assembly includes a seatbelt, a D-ring including a D-ring slot slideably receiving the seatbelt, a tongue including a tongue slot slideably receiving the seatbelt, and a buckle. The D-ring includes at least one of a magnet interface and metal interface. A tongue includes the other of the magnet interface and metal interface. The buckle and the tongue are releasably engageable.

The one of the magnet interface and metal interface can be convex, and the other of the magnet interface and metal interface can be concave.

The D-ring can include a first portion and a second portion, the second portion extending away from the first portion at an angle relative to the first portion and including the at least one of the magnet interface and metal interface. The angle can be a negative obtuse angle between 100 and 185 degrees.

The D-ring can define an opening, the opening sized to receive a fastener extending through the opening.

The D-ring can include the magnet interface, and the magnet can be an electromagnet.

The tongue can include a first portion and a second portion, the second portion extending away from the first portion at an angle relative to the first portion and including a plate to which the buckle can releasably attach. The angle can be a negative obtuse angle between 100 and 185 degrees.

The seatbelt assembly can include a retractor retractably receiving the seatbelt. The retractor can include a cable, the cable slideably extending through an aperture defined by the D-ring and attached to the tongue. The retractor can include a secondary retractor retractably receiving the cable.

A vehicle includes a pillar, a seat disposed adjacent the pillar, a seatbelt, a D-ring including a D-ring slot slideably receiving the shoulder belt, a tongue including a tongue slot slideably receiving the shoulder belt, and a buckle. The D-ring is fixed to a pillar, and includes at least one of a magnet interface and metal interface. The tongue includes the other of the magnet interface and metal interface. The buckle and the tongue are releasably engageable.

The one of the magnet interface and metal interface can be convex and the other of the magnet interface and metal interface can be concave.

The D-ring can include a first portion and a second portion, the second portion including the at least one of the magnet interface and metal interface. The second portion can extend away from the first portion at a negative obtuse angle relative to the first portion.

The D-ring can include the magnet interface and the magnet can be an electromagnet.

The tongue can include a first portion and a second portion. The second portion can include a plate to which the buckle can releasably attach. The second portion can extend away from the first portion at a negative obtuse angle relative to the first portion.

The vehicle can include a retractor retractably receiving the seatbelt. The retractor can include a cable, the cable slideably extending through an aperture defined by the D-ring and attached to the tongue. The retractor can include a secondary retractor retractably receiving the cable.

With reference to the Figures, wherein like numerals indicate like parts throughout the several views, a seatbelt assembly 28 for a vehicle 10 includes a seatbelt 30, a D-Ring 40 including a D-ring slot 42 for slideably receiving the seatbelt 30, a tongue 54 having a tongue slot 56 for slideably receiving the seatbelt 30, and a buckle 64. The buckle 64 and the tongue 54 are releasably engageable. The D-ring 40 includes at least one of a magnet interface 50 and metal interface 52, and the tongue 54 includes the other of the magnet interface 50 and metal interface 52.

Although illustrated as a sedan, the vehicle 10 may include any passenger or commercial automobile such as a car, a truck, a sport utility vehicle, a crossover vehicle, a van, a minivan, a taxi, a bus, etc.

The vehicle 10 may have a body 12. The body 12 may be formed of any suitable material, for example, steel, aluminum, etc. The body 12 may be sheet metal, e.g., steel. Alternatively, the body 12 can be of any other suitable material or combinations of material of any suitable thickness.

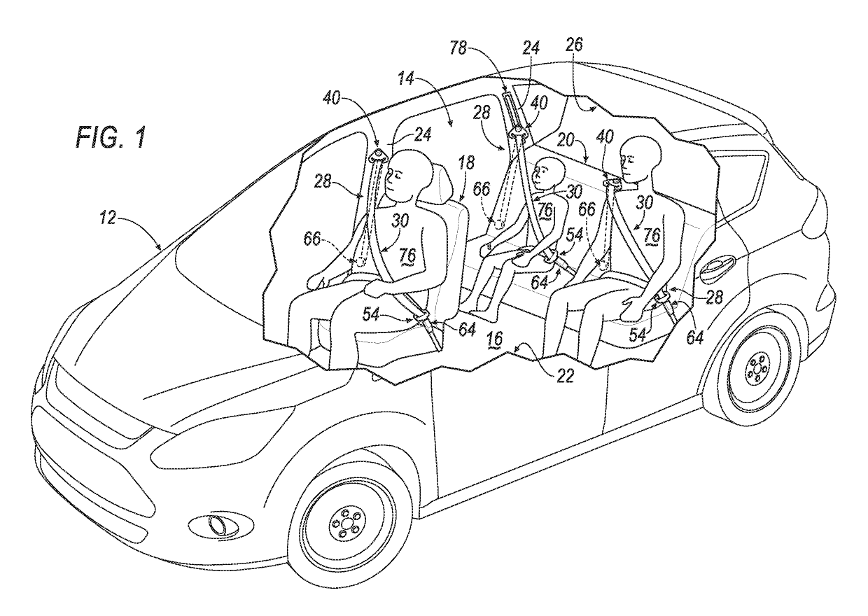

With reference to FIG. 1, the body 12 includes a passenger compartment 14. The passenger compartment 14 can include a floor 16, seats 18, 20, walls 22, pillars 24, and a roof 26. The seats 18, 20 can be, for example, mounted to the floor 16. The seats 18, 20, e.g., a front passenger seat 18 and a rear bench seat 20, can be disposed adjacent pillars 24.

The vehicle 10 can include one or more seatbelt assemblies 28. As discussed above, at least one of the one or more seatbelt assemblies 28 includes the seatbelt 30, the D-ring 40 including the D-ring slot 42 for slideably receiving the seatbelt 30, the tongue 54 including the tongue slot 56 for slideably receiving the seatbelt 30, and the buckle 64. The D-ring 40 includes the at least one of the magnet interface 50 and metal interface 52. The tongue 54 includes the other of the magnet interface 50 and metal interface 52. The tongue 54 and the buckle 64 are releasably engageable.

FIG. 1 illustrates an example of the seatbelt assembly 28 associated with the front passenger seat 18. The front passenger seat 18 is disposed adjacent the pillar 24. In this example, the tongue 54 and the buckle 64 of the seatbelt assembly 28 are releasably engaged in a buckled position.

The seatbelt 30 of the seatbelt assembly 28 associated with the front passenger seat 18 is positioned across a torso and a pelvis of an occupant 76 of the front passenger seat 18. As discussed above, the tongue 54 and the buckle 64 of the seatbelt assembly 28 are releasably engaged in the buckled position. As such, during, e.g., a frontal and/or rear impact of the vehicle 10, the seatbelt assembly 28 limits a displacement of the occupant 76 relative to the front passenger seat 18 in response to a vehicle acceleration caused by a vehicle impact.

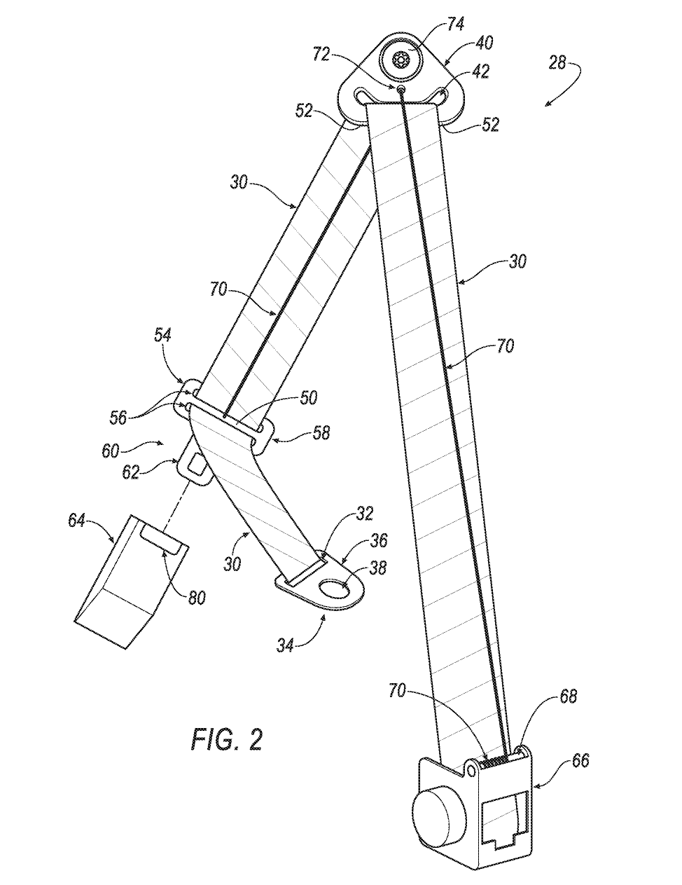

As shown in FIGS. 1 and 2, the seatbelt assembly 28 can include a retractor 66. The retractor 66 can rotatably receive the seatbelt 30 at a retractor end (not shown) of the seatbelt 30. In this way, the seatbelt 30 can be retractably extended from the retractor 66, i.e., extended from the retractor 66 by pulling the seatbelt 30 from the retractor 66.

In addition, the seatbelt 30 can be retracted into the retractor 66. For example, the retractor 66 can be spring-loaded such that the seatbelt 30 is automatically retracted into the retractor 66 when released. The retractor 66 can be an automatic-locking retractor, an emergency-locking retractor, a nonlocking retractor, etc. As shown in FIG. 2 and discussed further below, the retractor 66 can include a secondary retractor 68.

The retractor 66 can be fixed relative to the seat 18, 20. As shown in FIG. 1, for example, the retractor 66 of the seatbelt assembly 28 associated with the front passenger seat 18 can be mounted in the pillar 24 adjacent the front passenger seat 18. Alternatively, the retractor 66 of the seatbelt assembly 28 can be mounted to a seat structure (not shown), e.g., a seat frame, a support member mounting the seat 18, 20 to the floor 16, etc.

For example, in FIG. 1, two seatbelt assemblies 28 are shown associated with the rear bench seat 20. The seatbelt assembly 28 associated with a passenger side of the rear bench seat 20 includes a retractor 66 that can be mounted in the pillar 24 adjacent the passenger side of the rear bench seat 20. The seatbelt assembly 28 on a driver side of the rear bench seat 20 can include the retractor 66 mounted to the seat structure of the rear bench seat 20; i.e., the frame (not shown) of the rear bench seat 20.

Each of the two seatbelt assemblies 28 associated with the rear bench seat 20 can be positioned across a torso and a pelvis of occupants 76 of the rear bench seat 20. The tongue 54 and the buckle 64 of each of the two seatbelt assemblies 28 are shown in the buckled positon. As such, during, e.g., a frontal and/or rear impact of the vehicle 10, the seatbelt assemblies 28 limit displacement of the occupants 76 relative to the rear bench seat 20 in response to a vehicle acceleration caused by a vehicle impact.

The seatbelt 30 of the seatbelt assembly 28 can also include an anchored end 32. The anchored end 32 of the seatbelt 30 can be fixed to, e.g., attachment hardware 34. The attachment hardware 34 can be mounted to, e.g., the floor 16, the wall 22, the pillar 24, the roof 26, the seat structure, etc., of the passenger compartment 14.

The seatbelt 30 of the seatbelt assembly 28 can be formed of any suitable material. For example, the seatbelt 30 can be formed from polyester woven from about 300 warp strands and one weft strand.

As shown in FIG. 2, the anchored end 32 of the seatbelt 30 can be fixed to the attachment hardware 34. The attachment hardware 34 can include an attachment plate 36 defining an attachment-plate opening 38 sized to receive a fastener (not shown). The attachment plate 36 can be mounted to, e.g., the floor 16, the wall 22, the pillar 24, the roof 26, the seat structure, etc., of the vehicle 10.

For example, the floor 16, the wall 22, the pillar 24 and the roof 26 of the passenger compartment 14 can define an aperture (not shown) that can be aligned with the attachment-plate opening 38. The aperture can be threaded. The fastener, e.g., a threaded bolt, can extend through the attachment-plate opening 38 and into the aligned aperture in the floor 16, the wall 22, the pillar 24, the roof 26, etc., to mount the attachment plate 36 thereto.

Referring back to FIG. 1, for example, the attachment hardware 34 of the seatbelt 30 associated with the front passenger seat 18 can be mounted to the floor 16 of the passenger compartment 14 on an outboard side of the front passenger seat 18 (not shown); i.e., on a lateral side of the front passenger seat 18 proximate the wall 22 of the passenger compartment. Alternatively, the attachment hardware 34 can be mounted to the wall 22 of the passenger compartment 14 proximate the outboard side of the front passenger seat 18.

As discussed above, the attachment hardware 34 can also be mounted to the seat structure. For example, as shown in FIG. 1, the attachment hardware 34 of the seatbelt assemblies 28 associated with the rear bench seat 20 can be mounted to the frame and/or support structure of the rear bench seat 20 (not shown).

The seatbelt assembly 28 includes the buckle 64. The buckle 64 may be fixed to the seat 18, 20 or to the floor 16. For example, as shown in FIG. 1, the buckles 64 of the seatbelt assemblies 28 associated with the front passenger seat 18 and with the driver side of the rear bench seat 20 are fixed to the floor 16. As another example, the buckle 64 of the seatbelt assembly 28 associated with the passenger side of the rear bench seat 20 may be fixed to the seat structure (not shown).

The buckle 64 is configured to releasably engage the tongue 54 of the seatbelt assembly 28. For example, the tongue 54 can be inserted into a slot (not shown) in the buckle 64 and releasably retained by a mechanical feature of the buckle 64. The buckle 64 can include a release button 80 that, when depressed, releases the tongue 54 from the buckle 64 to an unbuckled position. In the unbuckled position, the seatbelt 30 can be automatically retracted into the retractor 66.

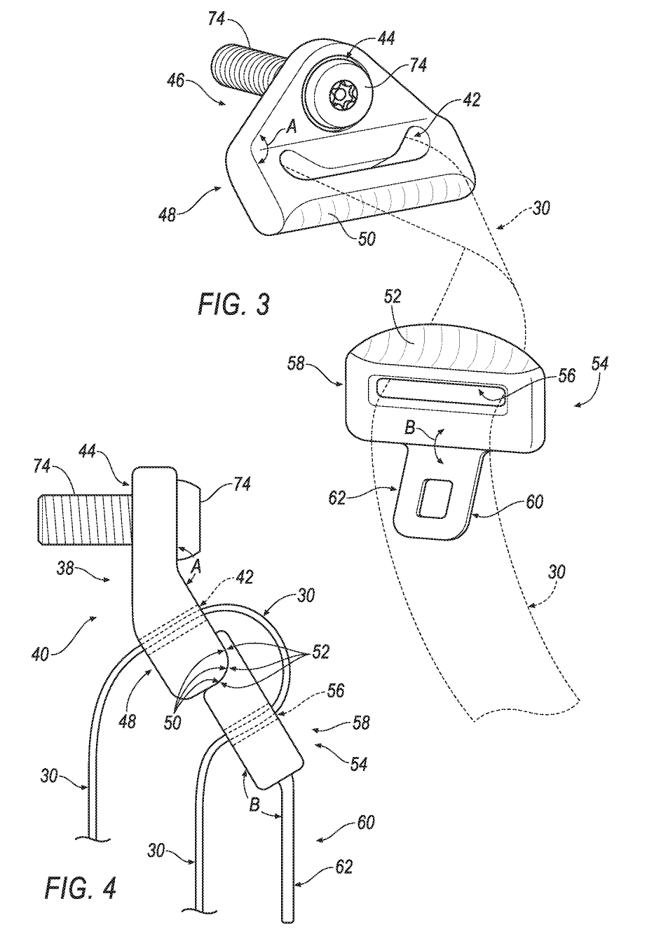

As shown in FIGS. 1-4, the seatbelt assembly 28 includes the D-ring 40. The D-ring 40 includes the D-ring slot 42 for slideably receiving the seatbelt 30. As shown in FIGS. 3-4, the D-ring 40 also includes at least one of the magnet interface 50 and the metal interface 52.

For example, in FIG. 3, the D-ring 40 includes the magnet interface 50 and the tongue 54 includes the metal interface 52. In FIG. 4, the D-ring 40 includes the metal interface 52 and the tongue 54 includes the magnet interface 50.

The D-ring 40 can be mounted to the floor 16, the wall 22, the pillar 24, the roof 26, the seat structure, etc. For example, as shown in FIGS. 3-4, the D-ring 40 can include a D-ring opening 44 sized to receive a fastener, such as a threaded bolt 74. The floor 16, the wall 22, the pillar 24, the roof 26, the seat structure, etc., can define an aperture (not shown) that can be aligned with the D-ring opening 44. The aperture can be threaded. The threaded bolt 74 can extend through the D-ring opening 44 and into the aligned aperture to mount the D-ring 40 thereto.

As shown in FIG. 1, for example, the D-ring 40 of the seatbelt assembly 28 associated with the front passenger seat 18 is mounted to the pillar 24, and spaced from the retractor 66. As illustrated by the D-ring 40 of the seatbelt assembly 28 associated with the front passenger seat 18, the D-ring 40 can be mounted to the pillar 24 such that the D-ring 40 is fixed relative to the pillar 24.

In another example, the D-ring 40 of the seatbelt assembly 28 associated with the passenger side of the rear bench seat 20 is mounted to the pillar 24, and spaced from the retractor 66. The D-ring 40 is vertically adjustable along the pillar 24. For example, the pillar 24 can include a vertical adjustment mechanism 78 to which the D-ring 40 is mounted. The vertical adjustable mechanism 78 can be released to vertically adjust the D-ring 40 along the pillar 24.

In another example, the D-ring 40 of the seatbelt assembly 28 associated with the driver side of the rear bench seat 20 is mounted to the seat structure, and spaced from the retractor 66.

In the example of the D-ring 40 shown in FIGS. 3-4, the D-ring 40 can include a first portion 46 and a second portion 48. The second portion 48 of the D-ring 40 can extend away from the first portion 46 at an angle A relative to the first portion 46. The angle A can be a negative obtuse angle. For example, the negative obtuse angle A can be between, e.g., 100 and 185 degrees.

As discussed above, the second portion 48 of the D-ring 40 can include the at least one of the magnet interface 50 and metal interface 52. In FIG. 3, the D-ring 40 includes the magnet interface 50. In FIG. 4, the D-ring includes the metal interface 52. The interface 50, 52 of the D-ring 40 can be concave or convex. The interface 50, 52 of the tongue 54 can be a complementary shape to the interface 50, 52 of the D-ring 40.

For example, as shown in FIG. 4, the metal interface 52 of D-ring 40 is convex. The magnet interface 50 of the tongue 54 is concave. Thus, the metal interface 52 of the D-ring 40 and the magnet interface 50 of the tongue 54 can magnetically attach along a greater surface area when the tongue 54 and the buckle 64 are in the unbuckled position, and the metal interface 52 of the D-ring 40 and the magnet interface 50 pf the tongue 54 are in contact. Alternatively, the metal interface 52 of the D-ring 40 can be concave, and the magnet interface 50 of the tongue 54 can be convex.

In one example of the seatbelt assembly 28, the magnet interface 50 of the D-ring 40 can be an electromagnet. For example, the D-ring 40 can include a metal wire coil (not shown) adjacent the magnet interface 50. One lead (not shown) from the coil can be attached to a power source, e.g., one end of a battery (not shown), and another lead (not shown) from the coil can connect to a switch (not shown) connectable to another end of the battery. When the switch is connected to the other end of the battery, the coil can generate an electromagnetic force. In this example, the metal interface 52 of the tongue 54 can magnetically attach to the magnet interface in the D-ring 40.

As shown in FIGS. 3-4, the seatbelt assembly 28 includes the tongue 54. The tongue 54 includes the tongue slot 56 for slideably receiving the seatbelt 30. As discussed above, the tongue 54 can include the other of the magnet interface 50 and the metal interface 52.

The tongue 54 can include a first portion 58 and a second portion 60. In the example of the tongue 54 of the seatbelt assembly 28 in FIGS. 3-4, the first portion 58 of the tongue 54 can include the other of the magnet interface 50 (FIG. 4) and the metal interface 52 (FIG. 3). The second portion 60 of the tongue 54 can extend away from the first portion 58 at an angle B relative to the first portion 58. The angle B can be a negative obtuse angle. For example, the negative obtuse angle B can be between, e.g., 100 and 185 degrees. The second portion 60 of the tongue 54 can include a plate 62. The plate 62 of the tongue 54 and the buckle 64 are releasably engageable, as discussed above.

As discussed above, the D-ring 40 can include an electromagnet as the magnet interface 50, and the tongue 54 can include a metal interface 52. Alternatively, the magnet interface 50 of the D-ring 40 and the tongue 54 can be formed from magnetically hard materials, such as alnico, ferrite, etc. The metal interface 52 of the D-ring 40 and the tongue 54 can be formed from iron, nickel, cobalt, rare-earth metals, and the like.

Another example of the seatbelt assembly 28 is shown in FIG. 2. In this example, the retractor 66 can include a cable 70 slideably extending through an aperture 72 defined by the D-ring 40 and attached to the tongue 54. The retractor 66 can rotatably receive the cable 70. Alternatively, as discussed above, the retractor 66 can include the secondary retractor 68, and the secondary retractor 68 can rotatably receive the cable 70.

The cable 70 can be retractably extended from the retractor 66 or the secondary retractor 68, i.e., extended from the retractor 66 or the secondary retractor 68 by pulling the tongue 54 away from the D-ring 40, with the cable 70 slideably extending through the D-ring aperture 72.

In addition, the cable 70 can be retracted into the retractor 66 or the secondary retractor 68. For example, the retractor 66 or the secondary retractor 68 can be spring-loaded such that the cable 70 is automatically retracted into the retractor 66 or the secondary retractor 68 when the tongue 54 is released from the buckle 64. In this way, the cable 70 can retract to tongue 54 back to the D-ring 40. In this example, the tongue 54 includes the magnet interface 50 and the D-ring includes the metal interface 52. Thus, the magnet interface 50 of the tongue 54 and the metal interface 52 of the D-ring 40 can magnetically attach.

The disclosure has been described in an illustrative manner, and it is to be understood that the terminology which has been used is intended to be in the nature of words of description rather than of limitation. Many modifications and variations of the present disclosure are possible in light of the above teachings, and the disclosure may be practiced otherwise than as specifically described.

What is claimed is:

1. A seatbelt assembly comprising:
a seatbelt;
a D-ring including a D-ring slot slideably receiving the seatbelt, the D-ring including one of a magnet interface and metal interface;
a tongue including a tongue slot slideably receiving the seatbelt, the tongue including the other of the magnet interface and metal interface; and
a buckle releasably engageable with the tongue.

2. The seatbelt assembly of claim 1, wherein one of the magnet interface and metal interface is convex and the other of the magnet interface and metal interface is concave.

3. The seatbelt assembly of claim 1, wherein the D-ring includes a first portion and a second portion, the second portion extending away from the first portion at an angle relative to the first portion and including the at least one of the magnet interface and metal interface.

4. The seatbelt assembly of claim 3, wherein the angle is a negative obtuse angle between 100 and 185 degrees.

5. The seatbelt assembly of claim 1, wherein the D-ring defines an opening extending through the D-ring, the opening sized to receive a fastener extending through the opening.

6. The seatbelt assembly of claim 1, wherein the D-ring includes the magnet interface and the magnet is an electromagnet.

7. The seatbelt assembly of claim 1, wherein the tongue includes a first portion and a second portion, the second portion extending away from the first portion at an angle relative to the first portion and including a plate to which the buckle can releasably attach.

8. The seatbelt assembly of claim 7, wherein the angle is a negative obtuse angle between 100 and 185 degrees.

9. The seatbelt assembly of claim 1 further comprising a retractor retractably receiving the seatbelt.

10. The seatbelt assembly of claim 9, wherein the retractor includes a cable, the cable slideably extending through an aperture defined by the D-ring and attached to the tongue.

11. The seatbelt assembly of claim 10, wherein the retractor includes a secondary retractor retractably receiving the cable.

12. A vehicle comprising:
a pillar;
a seat disposed adjacent the pillar;
a seatbelt;
a D-ring including a D-ring slot slideably receiving the seatbelt, the D-ring fixed to the pillar and including at least one of a magnet interface and metal interface;
a tongue including a tongue slot slideably receiving the seatbelt and including the other of the magnet interface and metal interface; and
a buckle releasably engageable with the tongue.

13. The vehicle of claim 12, wherein one of the magnet interface and metal interface is convex and the other of the magnet interface and metal interface is concave.

14. The vehicle of claim 12, wherein the D-ring includes a first portion and a second portion, the second portion including the at least one of the magnet interface and metal interface.

15. The vehicle of claim 14, wherein the second portion extends away from the first portion at a negative obtuse angle relative to the first portion.

16. The vehicle of claim 12, wherein the D-ring includes the magnet interface and the magnet is an electromagnet.

17. The vehicle of claim 12, wherein the tongue includes a first portion and a second portion, the second portion including a plate to which the buckle can releasably attach.

18. The vehicle of claim 17, wherein the second portion extends away from the first portion at a negative obtuse angle relative to the first portion.

19. The vehicle of claim 12 further comprising a retractor retractably receiving the seatbelt.

20. The vehicle of claim 18, wherein the retractor includes a cable, the cable slideably extending through an aperture defined by the D-ring and attached to the tongue.
